(19) United States
(12) Patent Application Publication
(10) Pub. No.: US 2006/0121426 A1
(43) Pub. Date: Jun. 8, 2006

(54) Online dating tools

(76) Inventors: Alvin Lynn Scoresby, Highland, UT (US); Benjamin Ryan Chase, Highland, UT (US)

Correspondence Address: THORPE NORTH & WESTERN, LLP., 8180 SOUTH 700 EAST, SUITE 200, SANDY, UT, 84070, US

(21) Appl. No.: 11/238,651

(22) Filed: Sep. 28, 2005

Related U.S. Application Data
(60) Provisional application No. 60/614,242, filed on Sep. 28, 2004.

(51) Int. Cl. G09B 19/00

(52) U.S. Cl. 434/236

(57) ABSTRACT

An online dating system and method is described. In one embodiment, the method include presenting online a personality profile with a built in honesty scale to help identify people trying to deceive and obtaining user responses to questions posed in the personality profile. In another embodiment, the method includes a staged communications approach to guide a pair of users through the process of getting to know each other online.

This application claims benefit of U.S. Provisional Patent Application Ser. No. 60/614,242 filed Sep. 28, 2004 and is incorporated herein in its entirety for all purposes.

### COPYRIGHT AUTHORIZATION

A portion of the disclosure of this patent document contains material which is subject to copyright protection, such as personality profile test material, interactive e-learning material, and web site content. The copyright owner has no objection to the facsimile reproduction by anyone of the patent document or the patent disclosure, as it appears in the Patent and Trademark Office patent file or records, but otherwise reserves all copyright rights whatsoever.

### DESCRIPTION OF FIGURES

FIG. 1 illustrates a method for conducting an online dating service in accordance with an embodiment of the present invention;

FIG. 2 illustrates a method for conducting an online dating service in accordance with another embodiment of the present invention;

FIG. 3 illustrates a method for conducting an online dating service in accordance with yet an embodiment of the present invention; and

FIG. 4 illustrates an online dating system and a computer program product in accordance with embodiments of the present invention.

### DETAILED DESCRIPTION

The invention provides online dating tools, which may be embodied in various forms such as methods, systems, products of processes, configured storage media, computer data structures, and the like. Unless otherwise stated, discussion of one form of embodiment illustrates but does not necessarily limit other forms of embodiment. For instance, discussion of methods of the invention illustrate systems of the invention, which may include computers configured to operate according to the methods, without necessarily requiring that the systems include every limitation discussed in connection with the methods. Likewise, the discussion of systems illustrates methods without necessarily limiting the methods, and so on, for each form of embodiment.

Reference is made to exemplary embodiments, and specific language will be used herein to describe the same. But alterations and further modifications of the inventive features illustrated herein, and additional applications of the principles of the invention as illustrated herein, which would occur to one skilled in the relevant art(s) and having possession of this disclosure, should be considered within the scope of the invention.

In describing the invention, the meaning of important terms is clarified, so the claims must be read with careful attention to these clarifications. Specific examples are given to illustrate aspects of the invention, but those of skill in the relevant art(s) will understand that other examples may also fall within the meaning of the terms used, and within the scope of one or more claims. Words used herein do not necessarily have the same meaning they have in everyday usage. Terms may be defined, either explicitly or implicitly, here in the Description and/or elsewhere in the application file(s). It is not necessary for every means or aspect identified in a given definition or example to be present or to be utilized in every embodiment of the invention.

Some of the description provided herein is taken from promotional materials, written for release after an online dating service (under the service mark “LDS Promise”) incorporating aspects of the invention is made publicly available. Some descriptions are thus phrased in the present tense, as though the invention was already commercially available at the time of filing this document, although not all aspects may be publicly available as of the time of writing this document. Moreover, promotional puffery should not be misinterpreted as factual statements regarding the characteristics of the invention in any embodiment, much less in every embodiment.

Definitions

Throughout this document, “you” generally refers to an end-user of the invention, e.g., someone looking for a compatible partner through use of an online dating service that operates according to the invention. Other users of the invention include, for example, entities that manage or operate such online dating services. In at least some cases, “we” refers to multiple end-users, to online dating service providers, or both. Depending on context, “we” may also refer to someone else.

Throughout this document, “Dating Service” refers to an online dating service that operates according to the invention. A given Dating Service may be tailored to a particular demographic group, e.g., according to stated religious preference, ethnic preference or perception, or otherwise targeted toward a specific community of end-users. However, a given Dating Service does not necessarily focus on a particular demographic.

Dating Service Introduction

The Dating Service promotes compatibility. Some existing online dating services match you with someone based on your same traits. You like walks on the beach and so does your match. You like a sunrise breakfast and will be happiest with someone who enjoys it too. You may be quiet or outspoken, adventurous or timid. You know that the best dates and marriages are between people who have similar hopes, dreams and personality traits.

At Dating Service, we match you based on similar traits with an added critical factor. However, many successful matches are not with people that are exactly alike in every area. What we want in the person we date and marry is equally important in creating the most successful compatibility. Dating Service matches you with people that have your same traits in important areas, plus what you want in a person to date and marry in other areas, such as interests, background, personality qualities, and religion. These elements make for a more powerful and successful match.

In some embodiments, the Dating Service process starts through our personality profile that covers a specified number of dimensions; other profiles cover a different number of dimensions or different dimensions. This profile will give you information about yourself. In one embodiment, twenty-two dimensions are grouped into seven scales that cover the spectrum of compatibility that makes you successful in dating. These are:

1. Gender confidence,

2. Communication effectiveness,

3. Social competence,

4. Emotional competence,

5. Cognitive competence,

6. Life management competence, and

7. Love and commitment.

Once the profile is completed and the compatibility scores are calculated, matching begins. You will be given matches that are both like you, and with traits that you want in someone. One thing that sets Dating Service apart from the competition is not only matching you with the person of your dreams, but what happens after the matching takes place. This is made possible through our Incremental Online Dating Communication approach.

In some embodiments, the matching process compares your likes with your prospective date's likes, your wants with the prospect's wants, your likes with the prospect's wants, and your wants with the prospect's likes. In some embodiments a subset of these four matching criteria are used to assess compatibility, e.g., want-to-like and like-to-want only, or want-to-want and like-to-like only. Different criteria may also be weighted differently. Additional criteria may also be used. Wants and likes may be determined through the personality profile and/or by more direct inquiries through radio button, checkbox, and other interfaces.

In some embodiments, after you take the personality profile test, there will be a simple profile and then a full profile available if you want to look at it. In some embodiments, there will be no partial matches but there is no perfect match either. The Dating Service may make available the complete profile to each person and they can allow the other person to see their profile too and see the areas in which they are strongest and those in which they are not as strong.

The Dating Service promotes communication. We know that online dating has some inherent risks because the person behind the other monitor may not be telling the whole truth. Our program has built in measurements for truthfulness and other risk factors, which is designed to identify the dishonest. Dating Service has created a complete and thorough system to maximize your time and dating experience. We help you and each person you are matched with by creating an environment that gets you talking and learning together.

We help you ask and answer questions. We provide skill building e-learning programs, tailored to your specific needs, and help you measure your progress in forming meaningful relationships. While you communicate, you will learn and improve. You can measure your progress with the person you have been matched with. As you progress through each stage, you will learn a great deal about the other person's goals, dreams and desires in a relationship.

You can decide at any time to move on to another match without the fear of negative feelings or the fear of not having new opportunities. We provide all of the tools and matches to make this process fun, exciting and complete.

The Dating Service promotes confidence. We help you build confidence in yourself and the people you are matched with. The combination of our process and your insight eliminates the guesswork so common in dating.

Through free and open communication, learning about the other person, providing several opportunities so that you can see how the person makes decisions, seeing if they can make and keep promises, and learning their willingness to participate in communication and progress in a relationship, you will experience a level of security and confidence that will lead you to more love and happiness.

We can give you confidence in the people you meet. We know you want to meet and date people you have confidence in. You want to have a lot of love and happiness in your life. Our profile test identifies people with positive interests, backgrounds, and the characteristics of the people you say you would like to meet. We create matches based on people that share your personality traits in addition to matching the traits you want in the people you meet. Our test also helps identify people who may be dishonest with the information they provide, and although it is not 100% foolproof, we use it to screen these individuals away from you.

Our communication system can help you tell whether the person you are communicating with is honest, responsible, and does what he or she says. With added confidence you can meet people and decide for yourself whether you want to communicate at all, communicate to create a good relationship, meet and go on dates, and communicate to build a lasting relationship. The choices are yours.

We help you succeed. Whether meeting new people results in a better marriage or not we want you to have useful and meaningful experiences with any person you meet. That is why we have reduced the possibility you will waste your time. We will stay with you. For those who do meet and prepare to marry, we promise to stay with you. When you are ready we provide a marriage preparedness test to help you see your strengths in a marriage and how prepared you are to be successful. Then we provide an archive of articles written by some of the foremost marriage experts which will help you learn about marriage communication, how to create a strong partnership, how to solve differences peacefully and many other marriage skills. We also provide you with a marriage skill building program which will help the two of you, as a couple, learn how to create love and happiness in your marriage relationship. This, along with a problem solving system, can be available to you after you are married to provide you with an insurance policy of skills, solutions, and methods of bringing happiness into your life.

Incremental Online Dating Communication

One example of Incremental Online Dating Communication for some embodiments of the invention is described below. Other examples for other embodiments differ, for instance, in aspects such as the specific questions asked in the personality profile, the scales and/or dimensions of the personality profile, the presence/absence of a personality profile, the specific reward for moving to a particular stage, the presence/absence of a face-to-face path, the interface used (progress bar, key, etc.), the omission or bundling of the stages shown here (e.g., omitting stage 5, combining stages 2 and 3 into a single stage), the addition of other stages, the number of e-learning programs used at a given stage (zero or more), and/or the content and title of a given e-learning program.

Stage 1

A. Explain test and simple results. Each person looks at the others simple results from the personality profile.
B. They each answer questions based on strengths shown in their profiles. (This type of questioning is called “meta-communication”). Meta-communication involves communicating about the process of communication within a relationship. This helps create investment in the communication process. People can talk about the best way to communicate with each other and then recognize why that works and is powerful in the relationship, so they can continue to do it successfully in the future.
C. Explain the two paths available—they can go directly to communication with each other or they can proceed with the stages. At any time they can choose to go directly to communication. Explain the progress bar and the need to each turn the key to go to the next stage. Explain how they can terminate the process with someone and move on to the next match. Explain e-learning and how it will be incorporated into the system.
D. The reward for moving to stage two will be access to the messaging tool.
   Stage 2
A. They receive information about the communication tool and how to effectively use it in the stages. We encourage them to begin using it to talk freely at this point and to get to know each other better. We will still provide structured questions and communication, but they should be talking too.
B. They each are asked to go through the first e-learning program, “Getting ready for a relationship”.
C. We again ask structured questions as part of the “meta-communication” process.
D. The reward for moving on to stage 3 will be visibility to each other's full personality profile. They turn the key.
   Stage 3
A. They see each other's full profile.
B. We suggest e-learning based on a weakness in the profiles. Only one e-learning is suggested.
C. Use meta-communication again based on these weaknesses and e-learning solutions.
D. Reward to move on from this stage is the ability to trade a photo.
   Stage 4
A. They show each other photos and other contact information.
B. They are encouraged to do any other e-learning that they desire or see the need for.
C. Encourage them to plan for the first date.
   Stage 5
A. Report and share feelings about the date
B. Last set of meta-communication questions are created around the first date experience.
C. They choose to go forward or move on to another match.

Throughout the communication process, individuals can be given the opportunity to go through specific e-learning programs according to weaknesses found in their profile. In one embodiment, the software will see where weaknesses are found and automatically offer the corresponding e-learning. This can be accomplished by previously specifying what threshold scores in what areas will trigger an offer to provide what e-learning.

Opportunities to make decisions are found in moving from one stage to the next. Each person has to click a button agreeing to move on. Within the stages, there is a progress bar that shows when agreed upon activities like e-learning are completed.

In some embodiments, the communication system has two paths (online and face-to-face coordinated online), with five stages each, that guide people through the process of getting to know each other. At any time, users can decide to abandon the communication steps and trade contact information, but many will desire the added confidence that comes through interaction in a structured environment. These five stages include many elements of a dating process to help each person see more and more of the true characteristics of their match.

Personality Profile Test

A copy of one suitable personality profile test is attached hereto, and incorporated herein, as Appendix A. Other personality tests may also be used. In some embodiments of the invention, no personality test is used. In some embodiments, a pre-existing personality test in used (either as is, or adapted), while in other embodiments a personality test created specifically for the invention is used.

In one embodiment, the profile can be used to find dishonesty because there are 50-60 questions throughout the test that are asked in slightly different ways and in different circumstances that will show if someone is just clicking answers or if they are trying to “beat” the test. In that embodiment, there are also 60-80 questions geared around psychological health that help determine if someone is emotionally healthy and able to tell the truth. Of course, other embodiments may use a different number of questions and/or different questions, to detect dishonesty. Response to detected dishonesty may include one or more of: notifying the tested person, notifying users the tested person is participating in staged communication with, notifying the online dating service administrator, and other actions. Notice of consequences of dishonesty can be given before the test is administered online, although the detection mechanism need not be described.

E-Learning Programs

Screen shots documenting a copy of one suitable e-learning program “Getting ready for a relationship” are attached hereto, and incorporated herein, as Appendix B. A script for another e-learning program, on “communication effectiveness” (which is an extended example of meta-communication for possible use with staged communication approaches) is attached hereto, and incorporated herein, as Appendix C. Other e-learning programs may also be used. In some embodiments of the invention, no e-learning program is used. In some embodiments, one or more pre-existing e-learning programs are used (either as is, or adapted), while in other embodiments one or more e-learning programs are created specifically for the invention.

In one embodiment, the e-learning program is implemented as an audiovisual Macromedia Flash file in the .SWF format, with animated text and textual effects, sound, and interactive features such as the display of text in response to the user positioning a cursor over a given text or icon and clicking a mouse button. Other familiar audio, visual, or audiovisual computer-based presentation technologies may also be used, as may other forms of user I/O and user interactivity.

Examples of possible e-learning titles include “how to get ready for dating,” “communication effectiveness,” “emotional competence,” and the like. In some embodiments, these e-learning programs are made available to all users but are also tied to the communication system (a.k.a., staged communication approach). In other embodiments they are available only through the staged communication approach. As areas of improvement are identified in personality profiles, specific e-learning programs can be recommended to give people an opportunity to learn and be more successful.

Face-to-Face Dating with Online Coordination Points

The Dating Service software states: You may find that communication online is not the same as it is face-to-face. Many people wish to meet their match right away and if you live close enough you may choose to use our face-to-face-and-online dating method. It gets you to the other person, gets you involved in getting acquainted, and it will help you succeed at having a good relationship. It works like this.
1. You contact your match through Dating Service and arrange a meeting. Make certain that this meeting is in a public place and at a time of day when you will be safe.
2. By email, password-protected posting online, or other electronic means, we give you small interesting assignments designed for men and for women to help you learn about and apply high quality relationship skills. We hope these assignments will intrigue and interest you. Have fun with them. Examples are given below.
3. You meet your date in person, face-to-face.
4. You return from your meeting and get your next assignments from Dating Service.
5. Later on, and only with your permission, we can arrange for you to see answers to what your match indicated he or she is like in the online personality profile discussed above, and/or the kind of person he or she wants to date.
   Example Assignments for Date 1: Making a Good First Impression

Start casual. Don't put a lot of pressure on yourself or your date. Creating unusually high expectations of what might happen, or worrying too much about what the person is going to think, can reduce the friendliness and warmth that makes a good impression. Have fun with the assignment while you are getting to know each other. Your goal is to see if you and the other person are interested in meeting again.

Man: Express interest in your date. Look at her face to see the color of her eyes. Show respect and regard for her. Seat her at the table, open doors, etc. Notice something about her and compliment her on it. Ask questions about her using the following starters (and maintain eye contact): “I would like to know . . . ”, “Can you tell me about . . . ”. Sometime during the date, tell her one thing you'd like to do with/in your life. Near the conclusion, express gratitude for her willingness to come on the date. If you're interested, initiate the next meeting whenever you choose.

Woman: Express interest in your date by looking at his face until you have a good idea about the color of his eyes. Telling some positive expectation about the meeting. Ask questions (while maintaining eye contact) using the following starters: “Would you tell me about . . . ”, “I would like to know . . . ”. Tell about things you're interested in . . . hobbies/interests. Smile, especially when you first meet and when he talks. Compliment him about something: the way he's dressed, the way he expresses himself. If interested in another meeting, accept his invitation or ask if he would like to meet again.

Example Assignments for Date 2: Getting Better Acquainted

The purpose for this date is to learn more about each other. We think that is a good idea for most people. How you go about learning about the other person, and how the other person responds creates and indicates interest. Further, each of you have given permission to show some of your test answers to each other. You can use these as conversation pieces to help achieve the goal of learning more about each other.

Man: During this date please learn three things: (1) What are her reasons for meeting you? You might ask her, “I would like to know why you were interested in getting together? (2) Does she have a more positive response to compliments, or questions, or attention? You will need to communicate each of those and observe how she responds. (3) What is her level of interest in you? You can tell this by how she long her answers are to your questions and how much attention she pays. To learn this, however, you will need to participate successfully. Test Questions, which may be answered by you online after the date: Would you like to know how she describes her own style of communication, how she wants someone to communicate?

Woman: On your second date you will have the opportunity to learn more about the person you are dating. During this date learn the following: (1) Does he have a positive attitude. You can learn this by listening to his language, asking him to tell about some successes and failures, and then by watching how he acts. (2) What are his reasons for meeting you? You may have to ask a direct question about this. (3) Does he respond more positively to your approval, to your warmth, or to your compliments? You will need to communication all three and see how he responds. Online test questions after the date: Would you like to know how he describes his communication style, or the type of communication he wants in a woman he dates?

Example Assignments for Date 3: Synchrony and Time

Two people in a good relationship are like ball room dancers. Each movement by one person is responded to by the other. How two people act and react to each other is called synchrony because what one person does or says is responded to by the other and so forth. Synchrony is the beginning step of all good relationships. Equally important, a person's interest in a relationship is often shown by how he responds to her and how she responds to him. You can promote a relationship you are interested in by making certain that your actions and your responses are in synchrony with one another.

Man: Your assignment is to lead the conversation to three different times: past, present, and future. Sometime during the date, tell about yourself and ask her questions about something in the past. Also tell something yourself which you are currently doing (the present time). Also during the date tell something, and/or ask her to tell you about something in the future (e.g. your goals, her goals, and etc.). See if she follows each time you tell about yourself in the past, present, and future. If she follows she is likely interested and is showing her willingness to participate in communicational synchrony. Online test questions after the date: Would you like to know how she described herself in her “love map” or the type of person she wants to date in her “love map”. Sample questions: (Past) “I would like to know something about your childhood.” (Present) “Can you tell me what you do at work?” (Future) “I am interested in knowing some of the things you would like to do or are looking forward to.”

Woman: Your assignment is to create synchrony in the conversation. This means that you must say and do something and then watch how he responds. It also means that you need to adapt your responses to something he says or does. Sometime during the time you are together, match the speed of his speech (e.g. if he talks fast, with a drawl, or talks slow then briefly imitate what he does). Nod once, twice, or three times when he talks. Smile to see if he smiles, smile in return at his smile. Touch your hair, arrange part of your clothing (like straightening out your collar or etc.) or adjust how you are sitting to see if he looks at, touches some part of his clothing, or adjust how he is sitting or standing. His willingness to join in the synchrony of your behavior indicates he is interested. Online test questions after the date: Would you like to know how he describes his own cognitive style, or what he wants in someone he dates?

Example Assignments for Date 4: Emotional Exchanges

Once synchrony has been created between two people they expand it to other parts of their lives. For instance, they might start responding to each other's communicational style and eventually expand it to exchanges with their feelings. What one person feels, responded to by the other person is called an emotional exchange. These “feeling,” experiences are the beginning of two people's attachment for each other which eventually become a love connection. You can act to create these feeling connections and see how interested the other person is.

Man: Get information about her emotional style. You have dated three times. On the fourth meeting it will be useful for you to better understand her emotional style. This includes, (1) how openly she shows what she feels, (2) how honest she is about what she feels, and (3) whether most of her feelings are positive or negative. You can learn about her emotional style by using some effective communicational tools. Would you like to know how she described her personality qualities, or what she wants in the person she dates? Use three communication tools. (Self disclose) Tell about a funny experience, a sad experience, and something you were very thankful or grateful for. See if she tells you a similar experience or something else. (Inquire) Ask her about a time when she felt loved, when she felt truly happy, and when she was anxious or frightened about something. (Observe) Watch her when she tells about her experiences to see which she is able to speak the most clearly about. She will reveal something about her emotional style by the length and fluency of her speech. The more open she is about her feelings, the more interested she is in spending time with you.

Woman: Learn about his emotional style. How he answers your questions signals his interest. A man often participates in the conversation of a relationship hoping to get more information about you than he gives about himself. This is because he will be cautious about revealing too much about himself too fast. He will consider it risky to tell about himself in personal terms. A man's willingness to risk, however, is often a sign of how interested he is in a woman. Use the communicational tools provided to help you learn more about his emotional style and his level of interest in you. Would you like to know what he gave as answers to “what I am like, “for his personality qualities”, or the personality qualities of the person he wants to date? During the fourth date please do the following. Tell him about some experience you have had and at the conclusion ask, “has anything happened to you like that?” Ask him what he feels about some event in his life like school, work, dating, religion, and etc. When there is a pause in his statements summarize his comments by saying, “you seem to be feeling . . . ” and then use the name of a feeling which was part of his comments. See if he accepts and/or agrees with your use of a feeling word. When he is talking about what he feels express interest and follow up by saying, “Tell me more about that . . . ”

Example Assignments for Date 5: Attachment

People who participate in relationships with synchrony and emotional exchanges start feeling more secure with each other and naturally feel closer to each other. This close feeling or attachment includes greater awareness of each other, more intense feelings of emotional intimacy, and greater sexual or physical interest. Sometimes this happens very quickly and may lead to more sexual interest more quickly than you are interested in. It may happen for one person before it happens for another. It is important that you proceed with the idea in mind that both people can and probably should progress at about the same pace. There are many people who have not had this experience or who have and it did not work out well for them. You might be reluctant to allow this to happen or you may be dating someone who is reluctant. You will need to decide now, whether you want to continue the relationship because if you let yourself feel closer to this person the relationship can and will move forward. If you do not let yourself feel something more, you might end it.

Man: Your assignment is to identify how secure you feel when you are with your date and how secure she is with you. Most women need to feel secure at the time of, or prior to, forming emotional attachments. If you wish to, you can encourage the development of her feelings by helping her feel secure around you. You can do this by asking her questions and talking about what makes people secure and what does not. Then ask yourself during the course of the date to see how secure you feel. You may even want to tell her if you think the timing is right. Your level of security is the measure of your attachment to this woman and her security is a fair measure of her attachment to you.

Post-date interactive Dating Service Test Questions: How does she describe her patterns of love and commitment? How does she describe the love and commitment patterns in the person she wants to date?

Communication Tools: Tell her you would like to talk about the idea of security and ask her if she would be willing to talk about that. Watch to see if she agrees. Ask her what the idea of security meets to her. (Watch whether she moves toward or away from you when she begins to answer.) Tell her about a relationship you have been in where you felt a strong sense of security. Watch to see if she agrees and if she suggests that she does or has done something similar. Ask her what has to happen in order for her to feel secure in a relationship with someone. Watch and see if she talks about men generally and what you do to help her feel secure. Watch to see how she expresses her feelings and how much she tells you. This will tell you how secure she feels about you.

Woman: Men seek security from you. They want to have at least a few definite plans about their direction and goals, a sense of adventure, and to see how well you match up to their expectations before they enter into and admit their feelings about attachments. However, like every person they can be encouraged to develop feelings if they participate and when the right kind of communication takes place. If you wish you can try out these forms of communication to see how the two of you are progressing toward feeling stronger feelings toward each other.

Interactive Test Questions: Do you know how he describes himself where love and commitment are concerned, or how he wants the person he dates to show love and commitment?

Communication Tools: Three to four times during the date look steadily at him and if possible hold his gaze for a moment or two. Watch and see if he gazes back at you. Ask him about his plans for himself, and/or what he wants to accomplish and/or his goals. Watch how definite he is and how secure he seems while talking. When he seems relaxed to you, tell him something similar to, “you seem to be quite relaxed tonight.” Watch and see if he agrees with you. If appropriate, tell him what a man does to help you feel secure around him and, if you wish, tell him what he does. Watch and see if that pleases him.

The Sixth Date:

The Dating Service software states: To this point we have suggested what you might do to give any relationship a real chance of succeeding. If you and the person you are matched with reach this point, then hopefully you have tried some of our assignments and found them to be fun and useful. Now, it is up to you. We suggest, however, that you apply one last assignment. This assignment is to find out and communicate two things. (1) What you want for yourself when you are in a relationship. This means the way you would like to act, not what you want from the other person. It will sound like “I want to be a person who pays attention.” (2) What you want in a high quality relationship. This will include how you want to communicate, how you want to feel, whether you like surprises or predictability, activities you like to participate in, how you want decisions to be made, and how you want affection to be shown or displayed.

By openly communicating what you want and learning what the other person wants, you can tell if the other person listens to you. You can tell how to please the other person. You can tell if you are respected and cared for. You can tell if you are progressing toward the type of relationship you hope for. A good relationship should provide many of the things you hope for and want. Good luck!

Illustrations

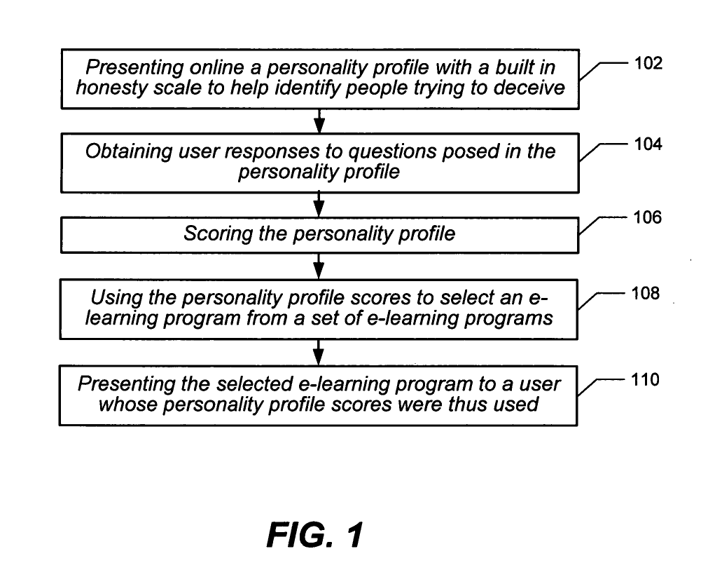

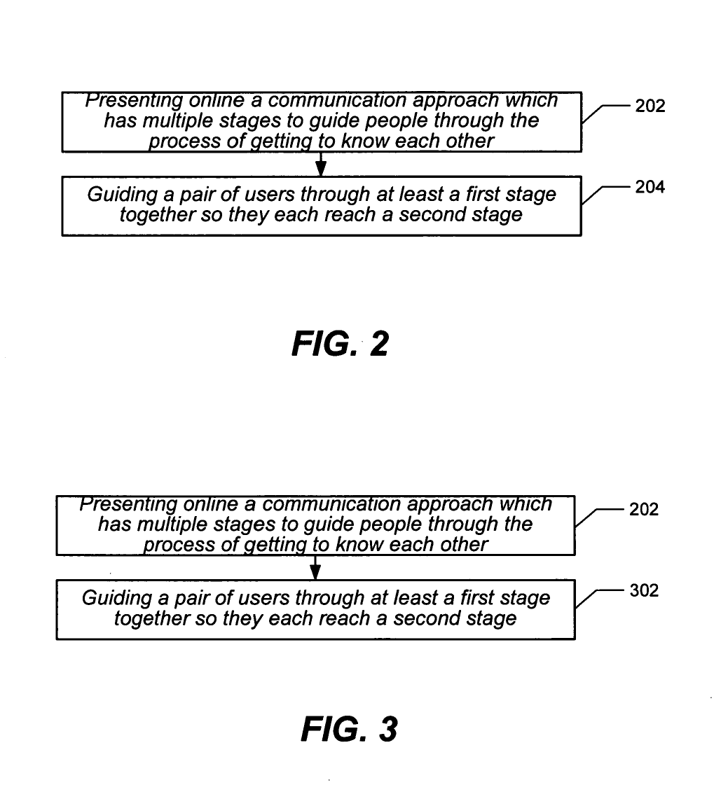

FIGS. 1 through 3 are flow charts of various embodiments of the present invention. As will be appreciated by one of skill in the art, each of the various steps in the flow chart may be implemented in a variety of ways to provide functions as described in further detail above. Additionally, the steps may be performed in various orders, including performing some steps simultaneously. Individuals steps may be performed by a computer system, a user, or a combination thereof.

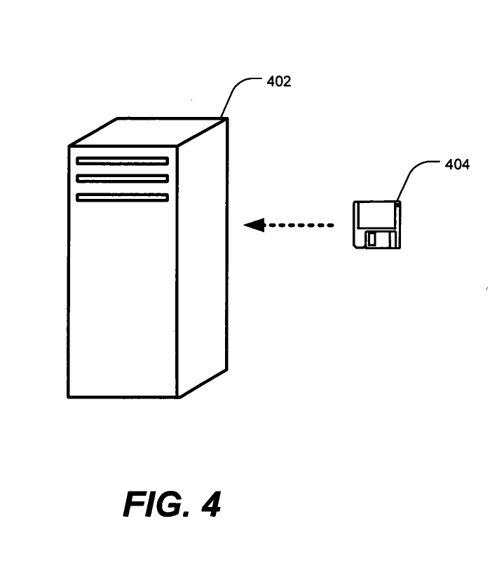

FIG. 4 illustrates an online dating system. For example, the online dating system may be implemented using a processor (402), such as a computer system, web server, or similar computing resources as would occur to one of skill in the art having possession of this disclosure. A computer program product (404) may contain computer readable code to implement the function of online data system. For example, the computer program product may include software to implement a web server, a user interface, or other system components of the online data system as would occur to one of skill in the art having possession of this disclosure.

### CONCLUSION

Although specific examples are given here, they are illustrative only, and the invention is not limited to end-users having any particular religious, ethnic, sexual orientation, race, age, income, language, or other personal characteristic.

The steps and other characteristics described herein may be combined in various ways to form embodiments of the invention. In methods of the invention, steps may be omitted, repeated, renamed, supplemented, performed in serial or parallel, and/or grouped differently, except as required by the claims and to provide an operable embodiment. In particular, not every step illustrated in a given example need be performed in a given method according to the invention.

System embodiments generally use a computer device (computer, PDA, cell phone, or other device with interoperating processor and memory) which is networked to an online dating service web site to perform one of the methods described herein. Different system embodiments may omit, repeat, regroup, supplement, or rearrange the system components discussed, provided the system overall is operable and conforms to at least one claim. To the extent that hardware, software, and firmware implementations are deemed partially or fully interchangeable at the time in question by one of skill in the art, they may be utilized in embodying the invention even though the specific examples discussed here are implemented differently.

Although particular embodiments of the present invention are expressly described herein as methods or devices, it will be appreciated that discussion of one type of embodiment also generally extends to other embodiment types. For instance, the descriptions of online dating methods also help describe online dating systems. It does not follow that limitations from one embodiment are necessarily read into another.

Headings are for convenience only; information on a given topic may be found outside the section whose heading indicates that topic. All claims as filed are part of the specification and thus help describe the invention, and repeated claim language may be inserted outside the claims as needed.

It is to be understood that the above-referenced embodiments are illustrative of the application for the principles of the present invention. Numerous modifications and alternative embodiments can be devised without departing from the spirit and scope of the present invention. While the present invention has been shown in the screen shots and described above in connection with the exemplary embodiments of the invention, it will be apparent to those of ordinary skill in the art that numerous modifications can be made without departing from the principles and concepts of the invention as set forth in the claims.

As used herein, terms such as “a” and “the” and designations such as “personality profile test” and “communicating” are inclusive of one or more of the indicated item or step. In particular, in the claims a reference to an item generally means at least one such item is present and a reference to a step means at least one instance of the step is performed.

The scope of the invention is indicated by the appended claims rather than being limited to the specific examples in the foregoing description and the Appendixes it incorporates. All changes which come within the meaning and range of equivalency of the claims are to be embraced within their scope to the full extent permitted by law.

What is claimed is:

1. A method for conducting an online dating service comprising:
presenting (102) online a personality profile with a built in honesty scale to help identify people trying to deceive; and
obtaining (104) user responses to questions posed in the personality profile.

2. The method of claim 1, further comprising scoring (106) the personality profile.

3. The method of claim 2, further comprising
using (108) the personality profile scores to select an e-learning program from a set of e-learning programs; and
presenting (110) the selected e-learning program to a user whose personality profile scores were thus used.

4. A method for conducting an online dating service comprising:
presenting (202) online a communication approach which has multiple stages to guide people through the process of getting to know each other; and
guiding (204) a pair of users through at least a first stage together so they each reach a second stage.

5. The method of claim 4, wherein the first stage comprises:
learning by each user in the pair partial results of a personality profile test taken by the other user in the pair; and
presenting each user with an overview of available e-learning on topics that include loving relationships.

6. The method of claim 4, wherein a stage after the first stage comprises turning on a feature that allows each user in the pair to send messages to the other user in the pair through the online dating service.

7. The method of claim 4, wherein a stage after the first stage comprises turning on a feature that allows each user in the pair to view a full personality profile of the other user in the pair through the online dating service.

8. The method of claim 4, wherein a stage after the first stage comprises turning on a feature that allows each user in the pair to view a digital photo of the other user in the pair through the online dating service.

9. The method of claim 4, wherein a stage after the first stage comprises turning on a feature that allows each user in the pair to obtain contact information of the other user in the pair through the online dating service, the contact information comprising a legal first name or nickname, legal last name, and at least one of: a home phone number, a home address, a work phone number, a work address.

10. The method of claim 4, wherein the communication approach includes a stage in which each user in the pair views part of the other user's personality profile test results, and a reward for moving to a later stage turns on a messaging capability so the two users can message each other through the online dating service.

11. The method of claim 10, wherein the communication approach includes a stage in which each user in the pair views an e-learning program on human relationships, and a reward for moving to a later stage is the capability of viewing each other's full profile through the online dating service.

12. The method of claim 10, wherein the communication approach includes a later stage in which each user in the pair views an e-learning program selected to strengthen a weakness in that user as measured by the user's personality profile test, and a reward for moving to a stage after the later stage is the capability of viewing each other's photo through the online dating service.

13. A method for conducting an online dating service comprising:
providing (202) an online communication approach which has multiple stages to guide people through the process of getting to know each other at least online; and
guiding (302) a pair of users through the multiple stages based on interactive responses from the pair of users.

14. The method of claim 13 wherein one of the multiple stages comprises matching a first user with second user based on both the first user's stated self-traits and the first user's stated desired-in-another-traits.

15. The method of claim 13 wherein one of the multiple stages comprises matching two users with each other based on each user's stated self-traits and on each user's stated desired-in-another-traits.

16. The method of claim 13 wherein one of the multiple stages comprises providing the pair of users with an online personality profile test and results.

17. The method of claim 14 wherein one of the multiple stages comprises guiding the pair of users through a stage in which they look at part of each other's online personality profile tests.

18. The method of claim 14 wherein one of the multiple stages comprises guiding the pair of users through a stage in which they each view an e-learning program to strengthen a weakness identified by an online personality profile test.

19. The method of claim 13 wherein one of the multiple stages comprises guiding the pair of users through a stage in which they each view an e-learning program on human relationships.

20. The method of claim 13 wherein one of the multiple stages comprises guiding the pair of users to a stage in which they each are given access to the other through messaging (email and/or instant messaging) through the online dating service as a reward for work completed in at least one prior stage.

21. The method of claim 13 wherein one of the multiple stages comprises guiding the users to a stage in which they each are given access to the other's full profile as a reward for work completed in at least one prior stage.

22. The method of claim 13 wherein one of the multiple stages comprises guiding the users to a stage in which they each are given access to the other's photo as a reward for work completed in at least one prior stage.

23. The method of claim 13 wherein one of the multiple stages comprises guiding the users to a stage in which they each are given access to the other's contact information as a reward for work completed in at least one prior stage.

24. The method of claim 13 wherein one of the multiple stages comprises guiding the users to a stage in which they plan a face-to-face date.

25. The method of claim 24 wherein one of the multiple stages comprises providing online assignments to each user to perform during an upcoming date between the users.

26. The method of claim 25 wherein one of the multiple stages comprises receiving reports from the users regarding online assignments, the reports indicating the extent to which the online assignments were performed during a previously-concluded date between the users.

27. The method of claim 13 wherein one of the multiple stages comprises giving a user an opportunity to see how another user makes decisions during participation in a staged communication approach.

28. The method of claim 13 wherein one of the multiple stages comprises giving a user an opportunity to see if another user keeps promises made during participation in a staged communication approach.

29. The method of claim 13 wherein one of the multiple stages comprises providing users with a marriage preparedness test to help them see their strengths in a marriage and how prepared they are to be successful.

30. A method for conducting an online dating service comprising setting conditions precedent for communication between prospective dating partners, and removing communication bars when the conditions precedent are satisfied.

31. A method for conducting an online dating service comprising providing staged communication online, and permitting two people to advance from one stage to the next when they both have met stated requirements.

32. A method for conducting an online dating service comprising providing a staged communication environment online, and providing two people with rewards in the form of increased access to information about each other when they meet stated requirements and move to a next stage of communication.

33. A method for conducting an online dating service comprising providing a communication environment online, and providing two people with access to increased communication in the environment conditionally based on their mutual acceptance of conditions and their agreement that each has met those conditions.

34. An online dating system comprising:
a processor (402) having a memory;
wherein the processor is configured to manage an online communication approach which has multiple stages to guide users through the process of getting to know each other at least online;
wherein at least one of the stages comprises presenting a user online a personality profile with a built in honesty scale to help identify people trying to deceive and obtaining user responses to questions posed in the personality profile.

35. An online dating system comprising:
a processor (402) having a memory;
wherein the processor is configured to manage an online communication approach which has multiple stages to guide a pair of users through the process of getting to know each other at least online;
wherein guiding the pair of users through the multiple stages comprises providing the pair of users with rewards in the form of increased access to information about each other when they meet stated requirements and move to a next stage of communication.

36. A computer program product comprising:
a computer useable medium (404) having a computer readable code means embodied in said medium for managing an online communication approach of multiple stages in an online data service, the computer readable program code in the computer program product comprising:
computer readable program code means for causing the computer to present a user online a personality profile with a built in honesty scale to help identify people trying to deceive and obtaining user responses to questions posed in the personality profile.

37. A computer program product comprising:
a computer useable medium (404) having a computer readable code means embodied in said medium for managing an online communication approach of multiple stages in an online data service, the computer readable program code in the computer program product comprising:
computer readable program code means for causing the computer to guide a pair of users through the multiple stages;
computer readable program code means for providing the pair of users with rewards in the form of increased access to information about each other when they meet stated requirements and move to a next stage of communication.
